(19) United States
(12) Patent Application Publication
(10) Pub. No.: US 2007/0277416 A1
(43) Pub. Date: Dec. 6, 2007

(54) Ornamental gift card holders

(76) Inventor: Wendy Fedan, Lyndhurst, OH (US)

Correspondence Address: ROETZEL & ANDRESS, 1375 EAST 9TH STREET, CLEVELAND, OH, 44114, US

(21) Appl. No.: 11/445,780

(22) Filed: Jun. 2, 2006

(51) Int. Cl. G09F 3/18

(52) U.S. Cl. 40/642.02

(57) ABSTRACT

A gift card holder has a main body dimensioned to accommodate a gift card of a common size, such as for example generally rectangular cards with approximate dimensions of 84 mm×55 mm, to engage or otherwise grip the card, and further having molded or structural or decorative features. Certain embodiments of the gift card ornaments further include a cavity in the main body which accommodates the planar card configuration and one or more gripping structures which engage the card in most cases at an edge to hold one or more cards in a predetermined position relative to the body of the ornament.

### FIELD OF THE INVENTION

The present invention is in the general field of gifts, ornaments and instruments of electronic commerce, including credit cards, debit cards and other types of electronic consumer transaction devices.

### BACKGROUND OF THE INVENTION

Gift cards which are magnetically encoded with cash or store credit are sold at face value at retail checkouts. The cards are commonly branded with the name of the store or a service provider such as telephone company service. Gift cards have become very popular because they are not limited to a specific item of merchandise or service, and they generate immediate cash to the sellers without requiring handling of physical goods. Gift cards can be in the various forms of simple proxy currency, with a cash value printed on the card, magnetically encoded “magstripe” type cards with the cash value encoded on a magnetic stripe, or any other embedded technology such as a “smart card” which carries a small integrated circuit and memory containing digital information on a cash amount, owner identity, time and date and place of purchase, etc., which can be electronically read for verification and redemption. All of the various forms of gift cards can be made in the known and standardized credit card size of approximately 86 mm×54 mm (3⅜″×2⅛″). Gift cards are merchandised by display at checkout counters, usually by attachment to a printed card suspended on a hanger (i.e., hang cards). Although this is one way of presenting gift cards to consumers, it is not very creative and does not emphasize or augment the gift-giving aspect of this type of product.

### SUMMARY OF THE INVENTION

The present invention provides ornaments for packaging and presenting gift cards in creative and practical manners. In accordance with one general aspect of the invention, there is provided a gift card holder which has a main body dimensioned to accommodate a gift card of a common size, such as for example generally rectangular cards with approximate dimensions of 84 mm×55 mm, to engage or otherwise grip the card, and further having molded or structural or decorative features. The gift card ornaments further include a cavity in the main body which accommodates the planar card configuration and one or more gripping structures which engage the card in most cases at an edge to hold one or more cards in a predetermined position relative to the body of the ornament.

In one particular embodiment of the invention, the body of an ornamental gift card holder has a cavity with a generally planar surface against which the planar surface of a gift card is placed, and one or more gripping structures which extend beyond or over the planar surface to engage an edge portion of the card to hold the card in position against the planar surface of the ornament body.

In another embodiment of the invention, the body of an ornamental gift card holder has an opening through which a portion of a gift card is exposed. Adjacent the opening is a pocket for receiving a portion of a gift card to position the card within the opening. The pocket may be dimensioned to frictionally engage a gift card therein. A side of the body opposite the pocket may be configured with relief or ornamentation about the opening to augment the appearance of the gift card in the opening.

In another embodiment of the invention, an ornamental gift card holder has a body which is in the form of an object and a cavity in the body which is dimensioned to receive and hold a gift card in relation to the body so that a portion of the gift card is visible relative to the body, and a portion of the body covers a portion of the gift card. A gripping structure can be formed in the cavity to grip and hold the gift card therein. The cavity may be in the form of a pocket external to the body with an opening, or internal to the body with an opening in the form a slot for receiving a card. When installed in the cavity in the body, a variable amount of the gift card may be visible relative to the body.

These and other alternate embodiments of the invention are described herein in detail as non-limiting examples of the forms in which the concepts and principals of the invention can be executed.

### DESCRIPTION OF THE FIGURES

FIG. 1A is a front elevation of an ornamental gift card holder of the invention;

FIG. 1B is a rear elevation of the ornamental gift card holder of FIG. 1A;

FIG. 2A is a front elevation of an alternate embodiment of an ornamental gift card holder of the invention;

FIG. 2B is a rear elevation of the ornamental gift card holder of FIG. 2A;

FIG. 3A is a front elevation of an alternate embodiment of an ornamental gift card holder of the invention;

FIG. 3B is a rear elevation of the ornamental gift card holder of FIG. 3A;

FIG. 4A is a front elevation of an alternate embodiment of an ornamental gift card holder of the invention;

FIG. 4B is a rear elevation of the ornamental gift card holder of FIG. 4A, and FIGS. 4C and 4D are side elevations of the ornamental gift card holder of FIG. 4A.

### DETAILED DESCRIPTION OF PREFERRED AND ALTERNATE EMBODIMENTS

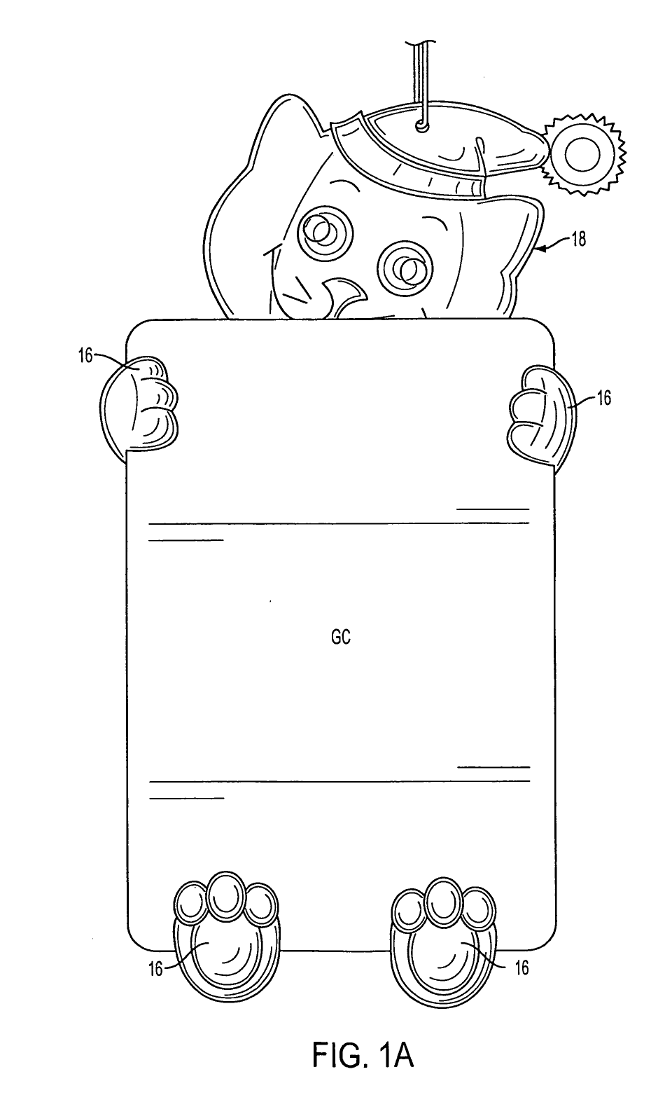

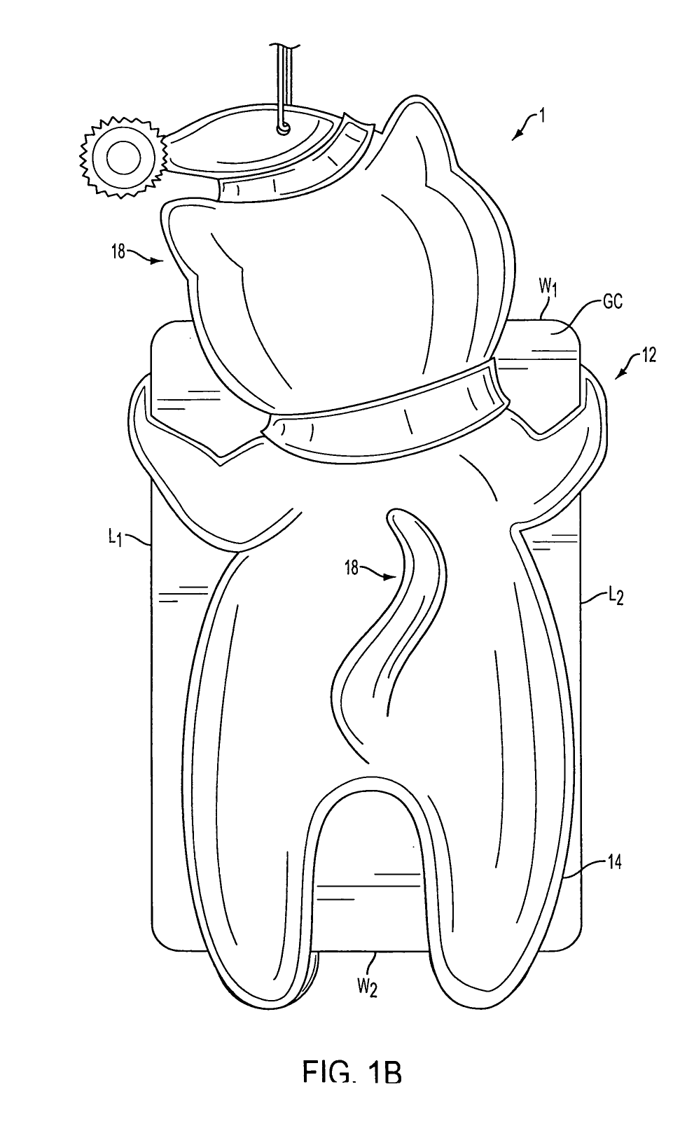

With reference to FIGS. 1A and 1B, there is shown an ornamental gift card holder of the invention, indicated generally at 1, which has a body 12 which is compatible in dimensions to a standard size credit card, e.g. 84 mm length×55 mm width and which may be greater or lesser in size. At least a part of the body 12 is greater than the width or length of the gift card GC so that a cavity in the body, or product attached to the body can receive and hold a gift card as further described. When dimensioned greater than a gift card, then a portion of body extends beyond one or both of the widthwise edges, W₁ W₂ and/or beyond one or both of the lengthwise edges L₁, L₂. In the example shown in FIGS 1A and 1B, portions of the body extend beyond both widthwise edges W₁, W₂ and both lengthwise edges L₁, L₂ of gift card.

Formed on the body 12 is a generally planar surface 14 against which at least a portion of the gift card GC is placed. The generally planar surface 14 may be formed on an exterior of body 12, as in the embodiments of FIGS 1A, 1B, or internal to the body as further described. When formed on the exterior of the body, the gift card GC is held in position against the surface 14 by one or more grippers 16 which extend about an edge of the gift card GC and over a surface of the card opposite surface 14. The grippers 16 are spaced from surface 14 approximately equal to or at areas slightly less than a thickness of the gift card GC to frictionally engage the card in position against surface 14. There can be as many as four or more grippers 16 as shown, for example to engage each edge of the gift card GC.

The remainder of the body 12 can be formed with relief or three-dimensional features 18 as shown, which may also extend beyond one or more of the edges of the card. The features 18 can be of any size or type, and may be both functional and aesthetic. When formed as an ornament, the body can be suspended by a hanger or fastener as shown, or not. The card is removed from the body 12 by sliding or bending it out of engagement with the grippers. For gift cards GC which have a magnetically encoded strip on one side, placement of the magnetic strip against the surface 14 of the body 12 protects the strip from damage.

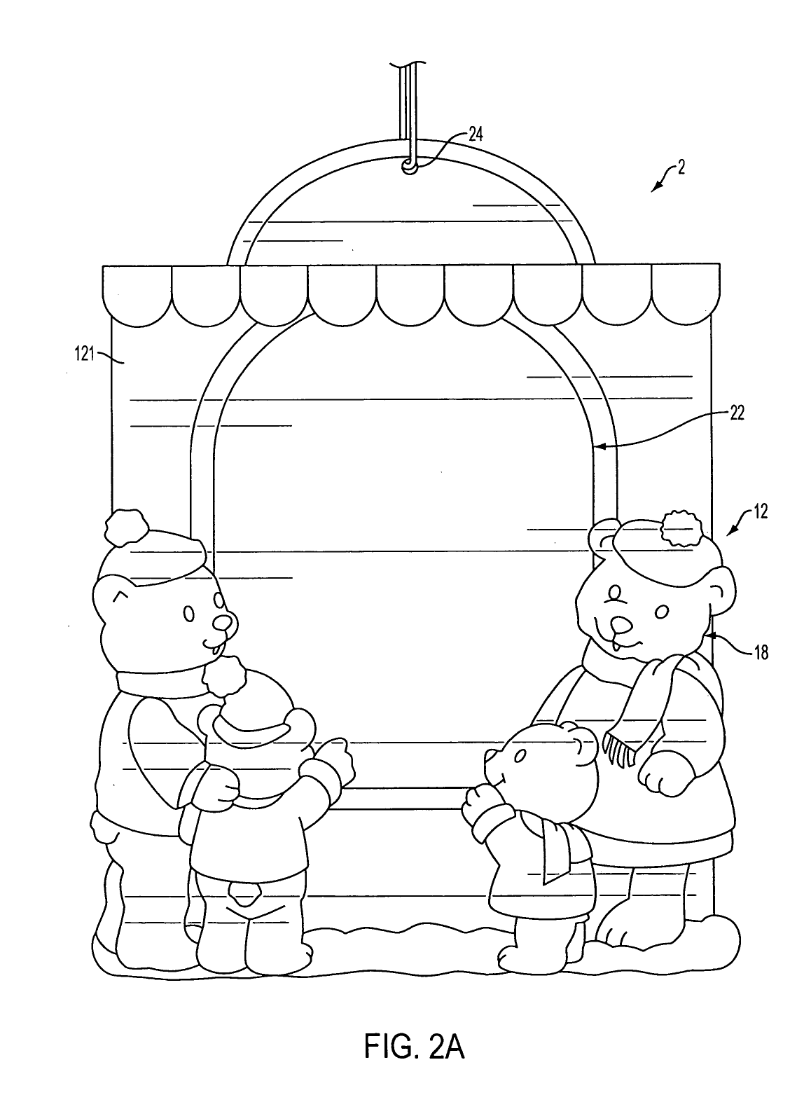

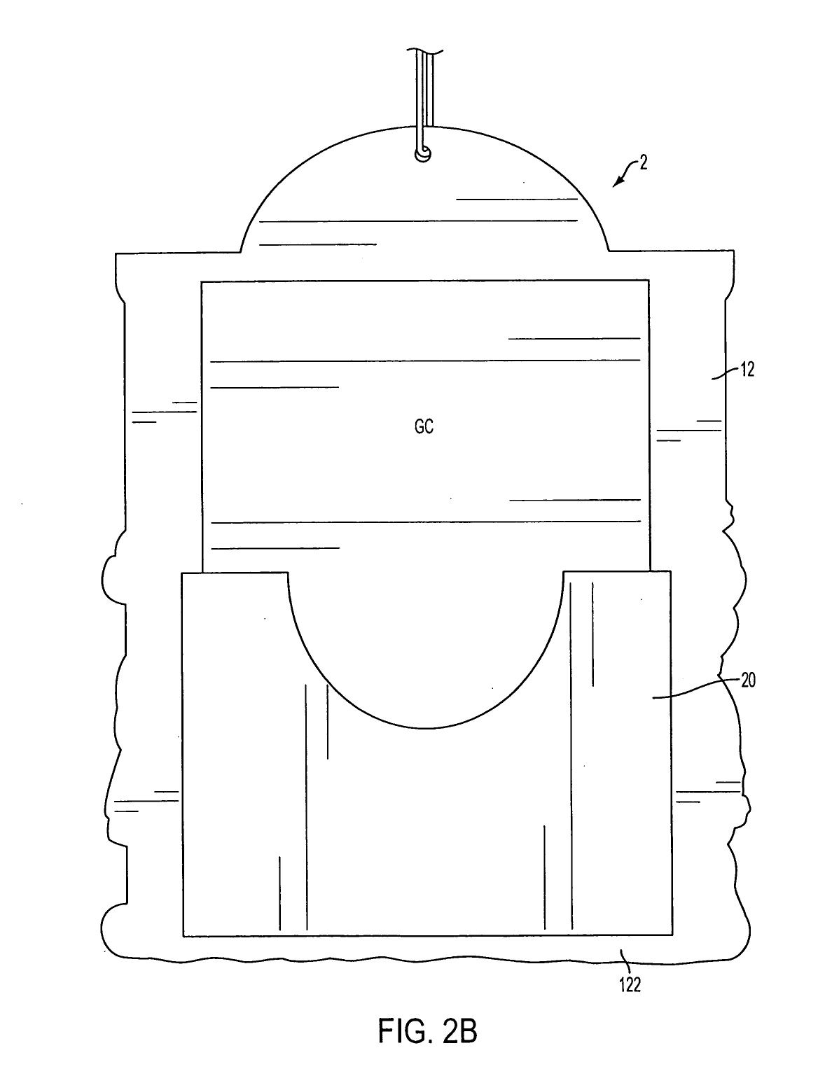

FIGS. 2A and 2B illustrate an alternate embodiment or an ornamental gift card holder, indicated generally at 2, wherein the body 12 includes a cavity or pocket 20 which is dimensioned to receive and hold a gift card GC of the conventional dimensions described, and wherein the body 12 substantially surrounds the edges of the card. A portion of the card GC is visible through an opening 22 formed in the body 12. Decorative or relief or design features, generally indicated at 18, can be formed about the periphery of the opening 22 on a front side 121 of the body 12, which features can be made to draw attention to or accentuate the presence of a card GC in the opening 22. The body 12 can be suspended, such as from suspension point 24, or otherwise supported or attached to any other object or structure. The pocket 20 in which the card GC is held can be formed on a back side 122 of body 12 so as to frictionally engage the edges and/or surfaces of the card GC, so that it is firmly held in place with respect to the ornamental gift card holder. The gift card GC is removable from the ornamental gift card holder by accessing an exposed portion of the card GC proximate to the backside 122 of the body 12.

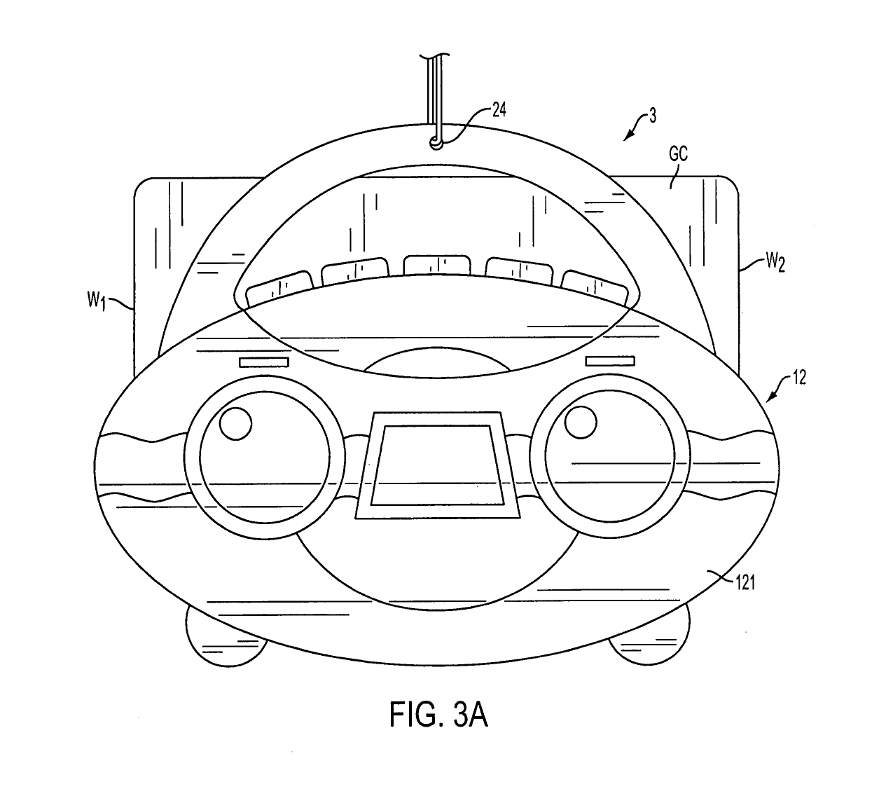

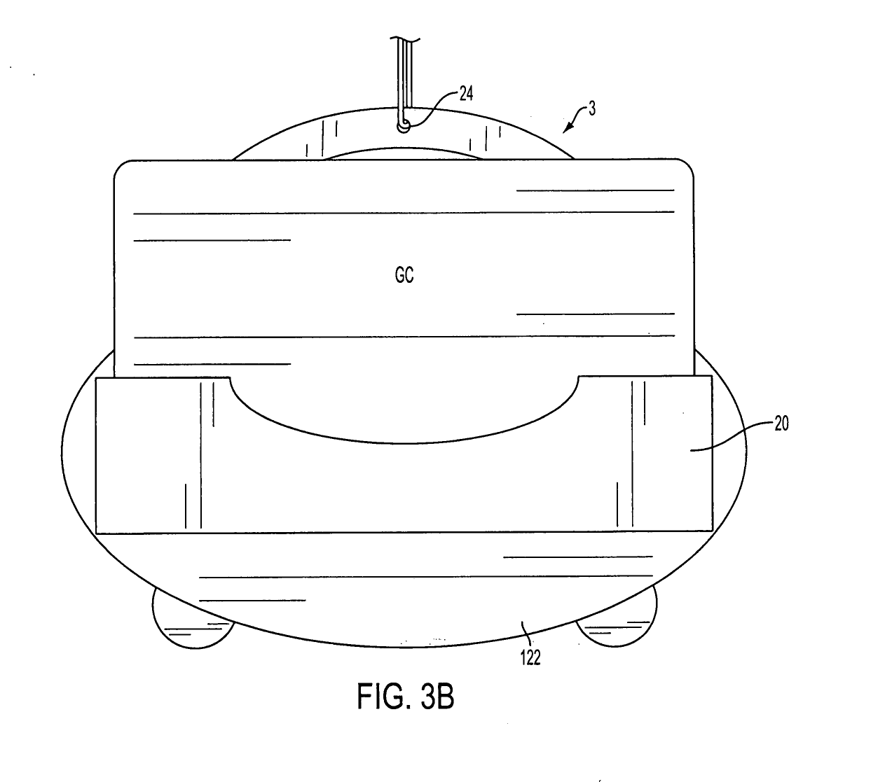

FIGS. 3A and 3B illustrate an alternate embodiment of the invention wherein the body 12 of an ornamental gift card holder 3 has a front side 121 which extends beyond the edges W₁, W₂, of a gift card GC. As shown in FIG. 3A, ornamental or design features generally indicated at 18, which may be graphical, colored and/or three-dimensional are formed on or with the front side 121 of the body 12. As shown in FIG. 3B, a cavity or pocket 20 is formed on or in the back side 122 of body 12 and dimensioned to receive at least one gift card GC, in this embodiment with the gift card GC inserted along a lengthwise edge. The cavity or pocket 20 can be dimensioned so that the gift card GC is frictionally engaged when inserted. Alternatively, one or more small protrusions can be formed within the cavity/pocket 20 to compress the gift card GC against the back side 122 of the body 12 to securely hold the gift card in place. As shown in FIG. 3A, a portion or even substantial portion of the gift card GC is visible beyond the body 12 when installed in the cavity or pocket 12, so that the gift card holder serves both as an ornament and as a display for the gift card GC. This provides for both products to be displayed together in a retail setting and sold as a combination. A suspension point 24 can be provided in a part of the body 12 or front face 121 which extends above the gift card GC.

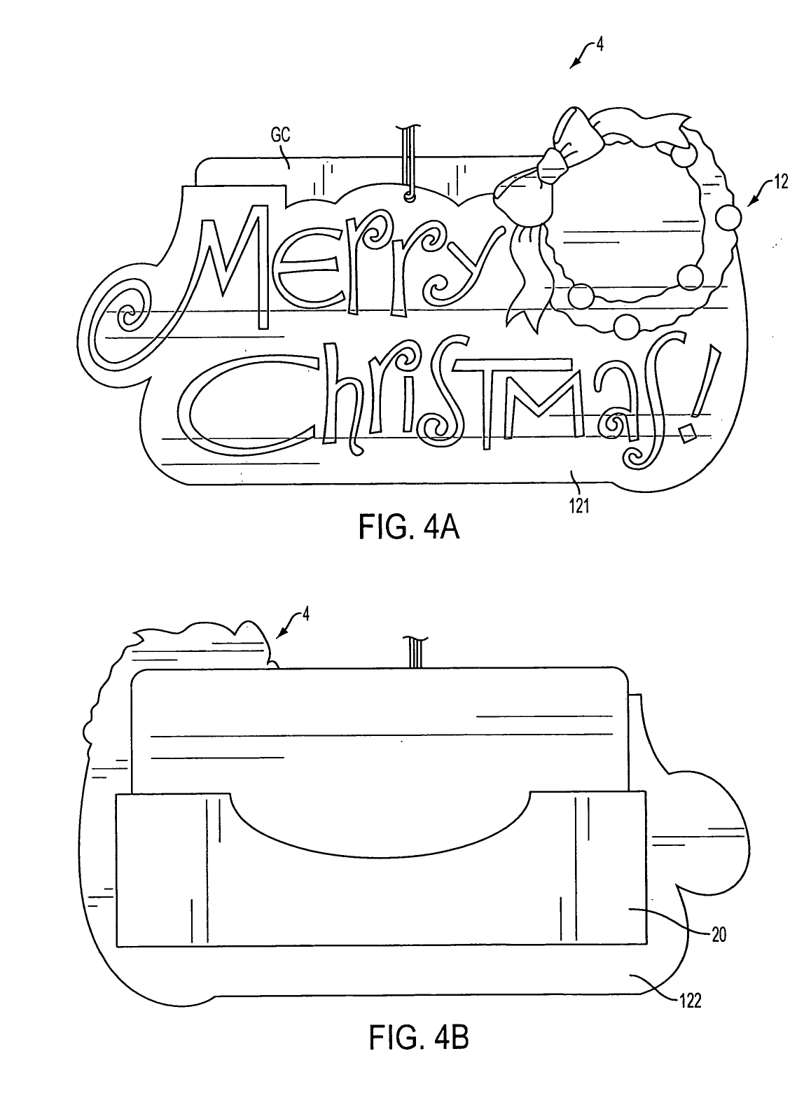

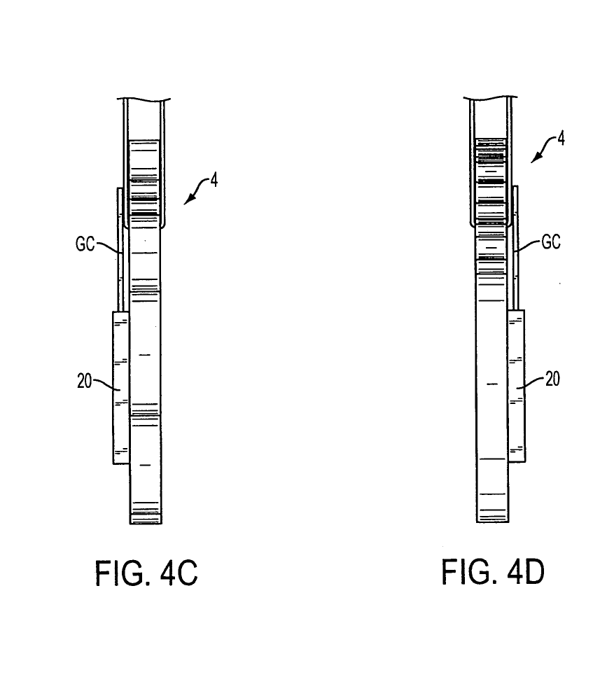

FIGS. 4A and 4B illustrate another alternate embodiment of the ornamental gift card holder 4 of the invention, wherein the overall dimensions of the body 12 are nominally commensurate with the length and width dimensions of a standard gift or credit card (i.e., approx. 86 mm×54 mm). With a pocket or cavity 20 formed in or attached to a back side 122 of the body 12 and dimensioned to receive a gift card GC in a lengthwise orientation as shown, a substantial portion of the gift card GC is concealed by the body 12. In the illustrated embodiment, a small portion of the gift card GC is visible rising above the front face 121 of the body 12. Also within the scope of the invention is a configuration wherein the gift card is entirely covered by the front face 121 of the body 12 of the ornament 1. Frictional or binding engagement of the gift card GC within cavity/pocket 20 either against the backside 122 of body 12, as shown in FIGS. 4C and 4D, or with protrusions 201 in the cavity/pocket 20 can be provided to secure a gift card GC in position with the ornament 1.

The invention thus provides novel articles for presentation of gift cards or cards of any type of the conventional gift card/credit card size. The ornaments can be re-used indefinitely and maintain their utility given the universal size convention for such cards.

What is claimed as the invention is:

1. An ornamental gift card holder in combination with a gift card, the combination comprising:
a body having a length dimension and a width dimension, at least one of the length dimension or width dimension being at least equal to or greater than a length dimension or a width dimension of a gift card, the body having a front side and a back side, and graphical or ornamental features on the front side or back side, and
a cavity formed on the back side of the body, the cavity being dimensioned to receive at least a portion of a gift card, the body being dimensioned such that edges of the front side and back side of the body extend beyond the cavity but do not extend beyond a portion of a gift card located within the cavity.

2. (canceled)

3. The ornamental gift card holder of claim 1 wherein the cavity associated with the body is the form pocket which is attached to the back side of the body, and edges of the back side of the body extend beyond the pocket,

4. The ornamental gift card holder of claim 1 wherein the cavity associated with the body is dimensioned to -frictionally engage a gift card inserted into the cavity.

5. The ornamental gift card holder of claim 1 further comprising at least one structure associated with the cavity which impinges upon a gift card in the cavity to secure the gift card within the cavity.

6. The ornamental gift card holder of claim 1 further comprising three-dimensional features on a front side or back side of the body.

7. The ornamental gift card holder of claim 1 further comprising one or more three-dimensional features which extend from the body and beyond an edge of the gift card.

8. (canceled)

9. The ornamental gift card holder of claim 1 further comprising an opening in a front side of the body through which a portion of a gift card inserted in the cavity is visible and edges of the body extending beyond at least one edge of the gift card in the cavity.

10. The ornamental gift card holder of claim 1 wherein a perimeter of the body is curvilinear and not parallel to any edges of a gift card inserted in the cavity.

11. A gift card holder having a body and a cavity for holding a generally planar rectangular card having a length dimension of approximately 86 mm and a width dimension of approximately 54 mm and a thickness dimension of 1 mm or less, the gift card holder comprising:
a body having a length dimension greater than 86 mm and a width dimension greater than 54 mm and a thickness dimension greater than thickness dimension of a gift card so that the length and width of the body is greater than a length and width of the cavity and extends beyond the length dimension and width dimension of a gift card recieved within the cavity;
a cavity formed with the body configured to receive a portion of a gift card therein so that at least a portion of the gift card extends beyond the cavity and is located and visible proximate to the body of the gift card holder.

12-13. (canceled)

14. The gift card holder of claim 11 wherein the cavity is the form pocket which is attached to the back side of the body.

15. The gift card holder of claim 11 wherein the cavity is configured to frictionally engage a gift card inserted into the cavity.

16. The gift card holder of claim 11 further comprising at least one structure associated with the cavity which impinges upon a gift card in the cavity to secure the gift card within the cavity.

17. The gift card holder of claim 11 further comprising three-dimensional features on a front side or back side of the body.

18. The gift card holder of claim 11 wherein the body further comprises one or more structures which extend from the body and beyond an edge of the gift card.

19. The gift card holder of claim 11 wherein the cavity is in the form of a generally planar area on a front or back side of the body.

20. The gift card holder of claim 11 further comprising an opening in a front side of the body through which a portion of a gift card inserted in the cavity is visible, and a portion of the body surrounding each side of the gift card.

21. The gift card holder of claim 11 wherein a perimeter of the body is curvilinear and not parallel to any edges of a gift card inserted in the cavity.

22. In combination, a gift card holder and gift card having a length dimensions L1 and L2 and width dimensions W1 and W2, the combination comprising;
a gift card holder having a body and a cavity which is attached to the body and configured to receive and engage the gift card so that the gift card id held by the cavity closely proximate to the body, the cavity dimensioned to receive and frictionally engage the gift card so that the length dimensions L1 and L2 and width dimensions W1 and W2 of the gift card fit closely within the cavity, the body having a maximum length dimension which is greater than the length dimensions L1 and L2 of the gift card and a maximum width dimension which is greater than width dimensions W1 and W2 of the gift card, a first side of the body having a substantially planar surface proximate to which the cavity is formed and the gift card is positioned, and a second side of the body opposite to the first side having three-dimensional features formed thereon, the gift card extending out of the cavity and beyond at least one of the edges of the body whereby a portion of the gift card is visible behind the second side of the body and proximate to the three-dimensional features of the second side of the body, the body covering a substantial portion of the gift card and edges of the second side of the body extending beyond and concealing portions of the edges of length dimensions L1 and L2 and width dimensions W1 and W2 of the gift card.

23. The gift card holder and gift card combination of claim 22 wherein the body has an opening through which a portion of the gift card is visible, and the body extends beyond each of the edges of the gift card.

24. The gift card holder of claim 22 wherein the cavity further comprises one or more small protrusions formed within the cavity and configured to compress the gift card against the body.

25. The gift card holder of claim 22 wherein the body further comprises a suspension point located beyond an edge of the gift card in the cavity.

26. The gift card holder of claim 22 wherein the cavity is configured to receive and hold a gift card along three edges of the gift card including two width edges W1 and W2 and one length edge L2, and a fourth edge L1 of the gift card is located outside of the cavity and proximate to the body.
